(19) United States
(12) Patent Application Publication
(10) Pub. No.: US 2010/0140479 A1
(43) Pub. Date: Jun. 10, 2010

(54) Apparatus and method for detecting a designated group of materials and apparatus and method for determining if a designated group of materials can be distinguished from one or more other materials.

(76) Inventors: Glenn Bastiaans, Torrance, CA (US); Jerald A. Cole, Long Beach, CA (US)

Correspondence Address: Lawrence S. Cohen, Attorney, Suite 1220, 10960 Wilshire Boulevard, Los Angeles, CA, 90024, US

(21) Appl. No.: 12/624,364

(22) Filed: Nov. 23, 2009

Related U.S. Application Data
(62) Division of application No. 11/512,963, filed on Aug. 29, 2006, now abandoned.
(60) Provisional application No. 60/712,213, filed on Aug. 29, 2005.

(51) Int. Cl. G01N 21/35; G01N 21/84; G01N 21/01

(52) U.S. Cl. 250/339.07; 250/339.11

(57) ABSTRACT

A method for detecting the presence of a target material comprising a source of a beam of terahertz radiation comprising illuminating a suspected subject with THz radiation having been determined to provide sufficiently clustered PCA classification to distinguish the target materials from non-target materials. The method further provides for determining the PCA classification for target materials as being sufficiently clustered and differently placed in n-space coordinates as to permit differentiating target materials from non-target materials. Then the weighting factors along with the n-spaced coordinates can be used for subjects under interrogation.

### RELATED APPLICATIONS

This application is a divisional of application Ser. No. 11/512,963 filed on Aug. 29, 2006 which claims priority from provisional application Ser. No. 60/712,213 filed on Aug. 29, 2005 the content of which is incorporated by reference herein.

### FEDERALLY SPONSORED RESEARCH

This invention was made with government support under grant No. NBCHC050019, awarded by the U.S. Department of Homeland Security. The Government has certain rights in the invention.

### FIELD OF THE INVENTION

The field of the invention relates to interrogation by THz radiation for materials of interest enabled by principle components analysis.

### SUMMARY OF THE INVENTION

The following summary is not intended to be a complete recitation or summary of all the claimed inventive content of this patent but rather as a helpful introduction to the description that follows.

The invention in one embodiment resides in an apparatus for detecting a material of a designated group in which a signature set of frequencies is constructed which is characteristic of the members of the group, that signature set being stored; a beam of terahertz radiation is directed at a subject which beam includes the signature set and the reflection of the beam is compared with the signature set. The beam may be pulsed. The pre-established group of materials comprises one or more explosives such as RDX, TNT, PETN and HMX.

In one embodiment the invention is a method of interrogating a subject for presence of any material that is a member of a designated group of materials and for distinguishing from other materials.

In another embodiment the invention resides in a method of determining whether or not a suspect material is a member of a designated group of materials which has been characterized by a signature frequency set of absorption spectra for which a PCA classification has been designated. This embodiment comprises the steps of exposing the suspect material to terahertz radiation comprising the signature set of frequencies; detecting reflected terahertz absorption spectra at the signature set of absorption spectral frequencies from the suspect material; carrying out a principle component analysis on the reflected spectra for constructing a PCA classification characterizing the suspect material and comparing the PCA classification characterizing the suspect material with the PCA classification characterizing the members of the designated group in a manner to determine whether or not there is a match therebetween.

In another embodiment the invention resides in a method for establishing criteria for determining whether a material is a member of a designated group of materials comprising; exposing each material considered for membership to the class to terahertz radiation; detecting reflected radiation from each prospective member; selecting frequencies in the reflected radiation at which two or more prospective members share an identifiable absorbance characteristic and carrying out a PCA classification fore the designated group of materials and storing the signature set.

In another embodiment the invention resides in an apparatus for detecting the presence of a material as belonging to a designated group of materials comprising a source of a beam of terahertz radiation comprising a set of frequencies having been previously determined to permit PCA classification data that is distinguishable from that of non-target materials in which the apparatus includes means for storing the PCA classification data; and means responsive to reflected terahertz radiation to determine PCA classification data for the suspect material and means for comparison of the PCA classification data of the suspect material with the previously stored PCA classification data of the target and determining a threat level based on analysis of the closeness of match of the PCA classification data of the suspect material to that of the target material.

In another embodiment the invention resides in a method of determining whether or not a suspect material is a member of a predefined class of members each characterized by a frequency signature set constructed by PCA at each of a plurality of frequencies at which members share an identifiable absorbance feature comprising exposing the suspect material to terahertz radiation comprising the plurality of frequencies; detecting reflected terahertz radiation from the suspect material; carrying out a PCA on the reflected radiation for determining PCA classification data for the suspect material and comparing the PCA classification data of the suspect material with the PCA classification data of the members of the predefined class in a manner to determine a threat level from the suspect material.

In another embodiment the invention resides in a method for establishing criteria for determining whether a material is a member of a designated group of materials comprising exposing each material of the designated group to terahertz radiation, detecting reflected radiation from each prospective member, selecting frequencies in the reflected radiation at which a plurality of members of the group share an identifiable absorbance characteristic, carrying out a PCA on the selected frequencies for obtaining PCA classification data for the class and storing the PCA classification data

### BRIEF DESCRIPTION OF THE DRAWINGS

FIG. 1 shows in textual form the definition of the terahertz region of the electromagnetic spectrum and examples of sources and detectors of terahertz radiation.

FIG. 2 shows in textual form the advantageous features of terahertz radiation for the present invention.

FIG. 3 shows attenuation of THz radiation through humid air as a function frequency.

FIG. 4 shows in schematic form an exemplary representation of how an apparatus can be deployed for a standoff detection implementation of the present invention.

FIG. 5 shows how false color imaging can isolate a subject and/or suspicious points of THz reflection for the present invention.

FIG. 6 shows in textual form an outline of the problem addressed by the present invention

FIG. 7 shows in textual outline the general approach of the present invention

FIG. 8 shows a schematic diagram of typical THz-TDS system used to measure THz reflection spectra of solid materials.

FIG. 9 shows the molecular structure of the explosive materials whose THz absorption spectra were measured in the exemplary experimental work.

FIG. 10 shows Absorption spectra, via transmission and baseline corrected, of four explosives uncovered and covered with common materials, paper, polyethylene sheet, cotton cloth, and leather. Spectra are changed very little by these “THz transparent” coverings.

FIG. 11 shows absorption spectra of non-explosive compounds, soap, salt, flour, and sugar. Spectra were obtained in transmittance mode and are baseline corrected. These spectra differ significantly from the spectra of explosives.

FIGS. 12-15 text portions explain in summary form the steps for classification via PCA in the present invention.

FIGS. 13a and 13b show plots representative of spectral data from explosives after processing using principles of principle component analysis as described in FIG. 12.

FIG. 14 shows a scatterplot representation of spectral data from both explosives and non-explosives after processing using principles of principle component analysis as described in FIG. 12.

FIG. 15 shows scatterplot of z scores from transformed spectra of explosives, explosives with coverings and non-explosive compounds using four signature frequencies. The clustering of points corresponding to all explosive samples demonstrates that classification of the compounds can be achieved by THz spectroscopy via principal component analysis using as few as four signature frequencies.

FIG. 16 is a textual presentation of conclusions.

FIG. 17 is a textual presentation of a summary.

FIG. 18 illustrates an exemplary installation such as in an airport for identifying a subject and operating the standoff explosive detection system as herein described.

FIG. 19 is a flow chart for the process of obtaining the PCA classification data needed in a system for detecting a set of target materials (also referred to as compounds of interest).

FIG. 20 is a general flow chart showing how the system and methods are operated after PCA classification data have been obtained.

FIG. 21 is a flow chart of the detail of block 222 from the flow chart of FIG. 21.

FIG. 22 is a block diagram of the system.

### DETAILED DESCRIPTION

The invention is based on the recognition that principle component analysis permits the determination of a THz signature frequency set for absorption spectra, which can be used to determine if a material that is interrogated by THz radiation belongs to a designated group of materials whose presence is of interest. The signature frequency set is a set of THz frequencies selected from absorption spectra from the materials that make up the designated group. The signature frequency set is determined by subjecting selected frequencies of the absorption spectra to PCA and varying the selected set until satisfactory PCA classification data is acquired. Satisfactory data is based on the closeness of z scores in selected coordinate axes such that the spectra for the members of the group are sufficiently close together such that other materials when interrogated with THz radiation will provide absorption spectra that when converted to PCA classification data can be differentiated from the PCA classification data for the designated materials. The differentiation is based on location in N-space of the materials of interest being sufficiently different from that of other materials. The term designated materials means a group of materials whose presence is under inquiry; it can also mean a condition of a group of materials where presence of the condition is under inquiry. In the first step the signature frequency set is determined by sequentially subjecting selected sets of frequencies from the absorption spectra of the designated group of materials and, using PCA, obtaining classification data until a set of frequencies is found that is satisfactory. In a related step, PCA classification is obtained for materials that are desired to be excluded from detection and the PCA classification for the designated group is sufficiently distant in N-space coordinates that detected absorption spectra for the designated group is distinguishable from the presence of the other group (the excluded group).

In a surveillance context any suspect material exposed to a beam of terahertz radiation comprising the signature frequency set exhibits a reflection spectrum from which the signature frequency set spectra (reflected spectra) are extracted. The reflected spectra are processed by principle component analysis to obtain classification data and that data is compared with the classification data for the signature frequency set. If a match occurs, the suspect material is determined to be a member of the designated group. A match is based on statistical analysis to determine some level of probability that a member of the designated group is present.

Explosives represent one such designated group established by a signature frequency set based on optical absorbance observed at as few as four or five frequencies. The following description refers to methods and apparatus for detection of hidden explosives in a context where the interrogating THz radiation will also cause absorption spectra from innocent materials, and the need is to be able to distinguish probable explosive materials from the innocent materials. The use of THz radiation allows sufficient standoff distance that interrogation or surveillance can be accomplished without closely approaching the suspected individual holding explosives or a suspected package with explosives.

The discovery that, through THz spectroscopy along with PCA, of absorption spectra, a set of signature frequencies could be identified that have PCA classification characteristics that are sufficiently different from the PCA classification data for common innocent materials was a key to the present invention.

A detailed discussion of the invention in the aspect of hidden explosive detection is contained in the attached document to the provisional application from which priority attaches, Attachment A, entitled Polychromic Imaging for Standoff Detection of Explosives and Weapons the content of which is incorporated by reference into this description. The method is to distinguish innocent materials from explosive materials by use of a predetermined THz signature set, to measure the relative intensities of the reflected signal from a subject under interrogation, the absorption spectrum at each of the frequencies; then to examine and treat the intensity data to PCA analysis to obtain PCA classification; and then to compare that result with the previously obtained PCA classification data for the explosives.

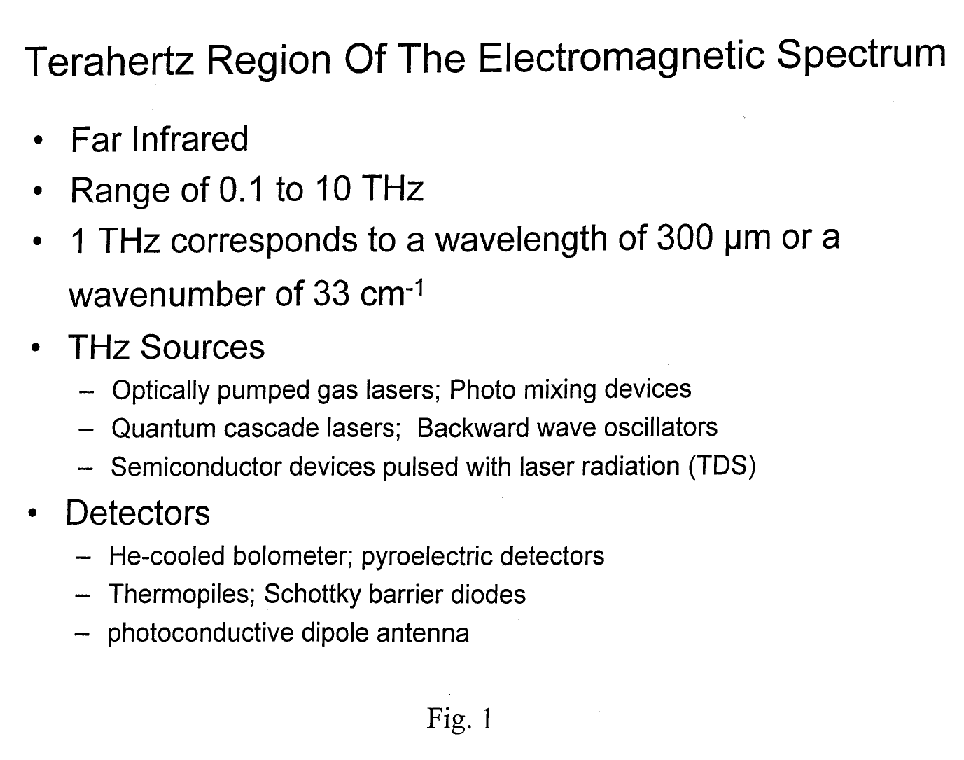

FIG. 1 is a textual presentation of three categories that are involved in the present invention; a description of the terahertz spectrum; some examples of THz sources and some examples of detectors that can be used to implement the invention.

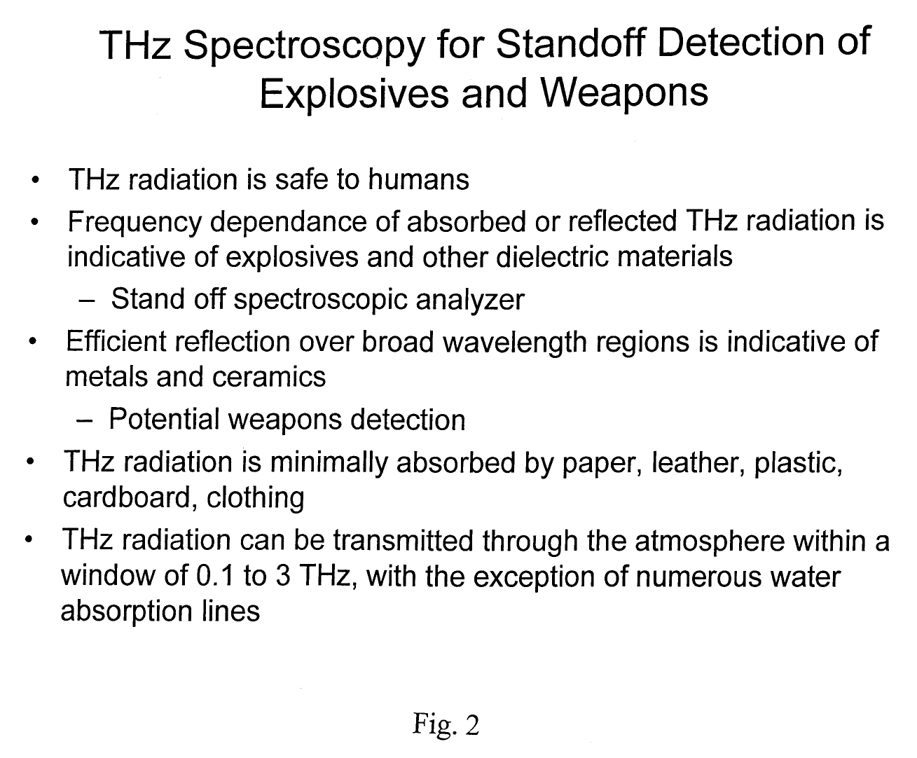

FIG. 2 is a chart that explains the advantages of using THz reflection spectroscopy to detect concealed explosive materials and weapons.

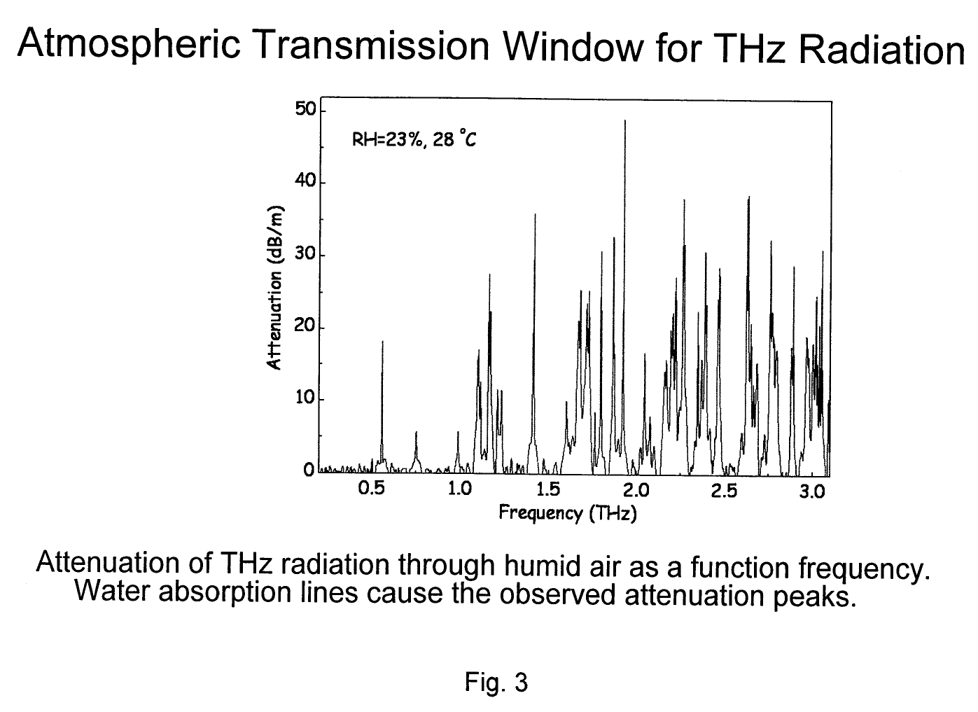

FIG. 3 is a graph that shows attenuation of THz radiation through humid air as a function of frequency, showing frequencies where the absorption of THz radiation by water in the atmosphere would interfere with the detection of explosives with THz radiation. Water absorption lines cause the observed attenuation peaks. Many frequencies exist where significant interference will not exist.

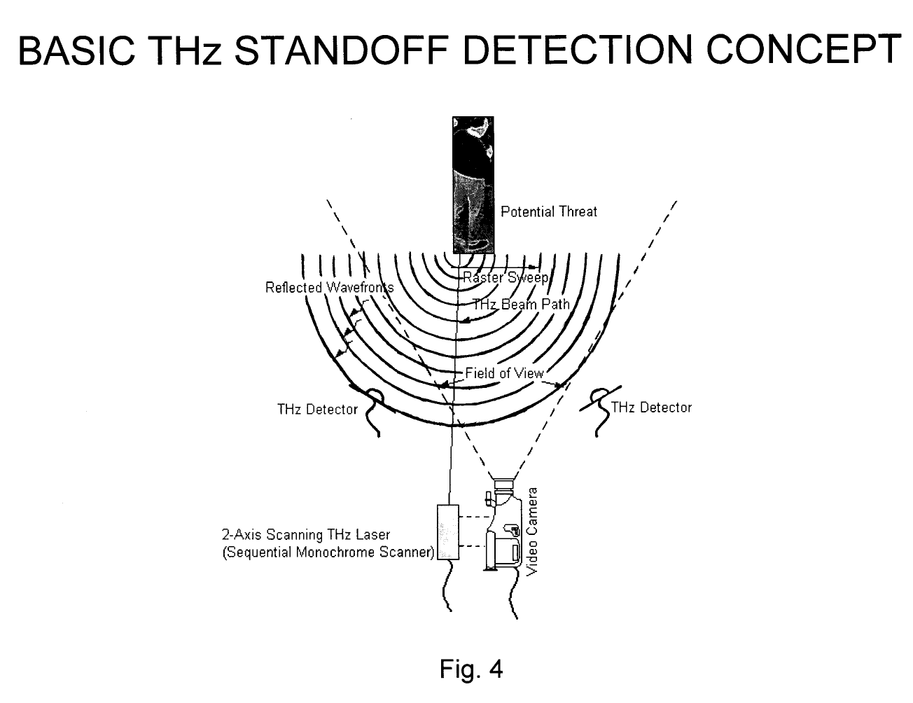

FIG. 4 illustrates a basic THz standoff detection concept using the present invention. As shown, an image of reflected THz radiation can be obtained by scanning a narrow beam of THz radiation over the scene of interest; in this case a 2-axis scanning THz laser (sequential monochrome scanner) interrogates the subject, a potential threat. The THz beam can be scanned using a moving mirror. Reflections are detected with one or more THz detection devices. Spectrographic analysis is instituted by the THz detectors which detect the reflected signal. The video camera can obtain a visible light image that can be superimposed on the scanned image. The superimposed combination of scanned and camera images can be used to associate suspicious reflections with people or objects of interest in the scene.

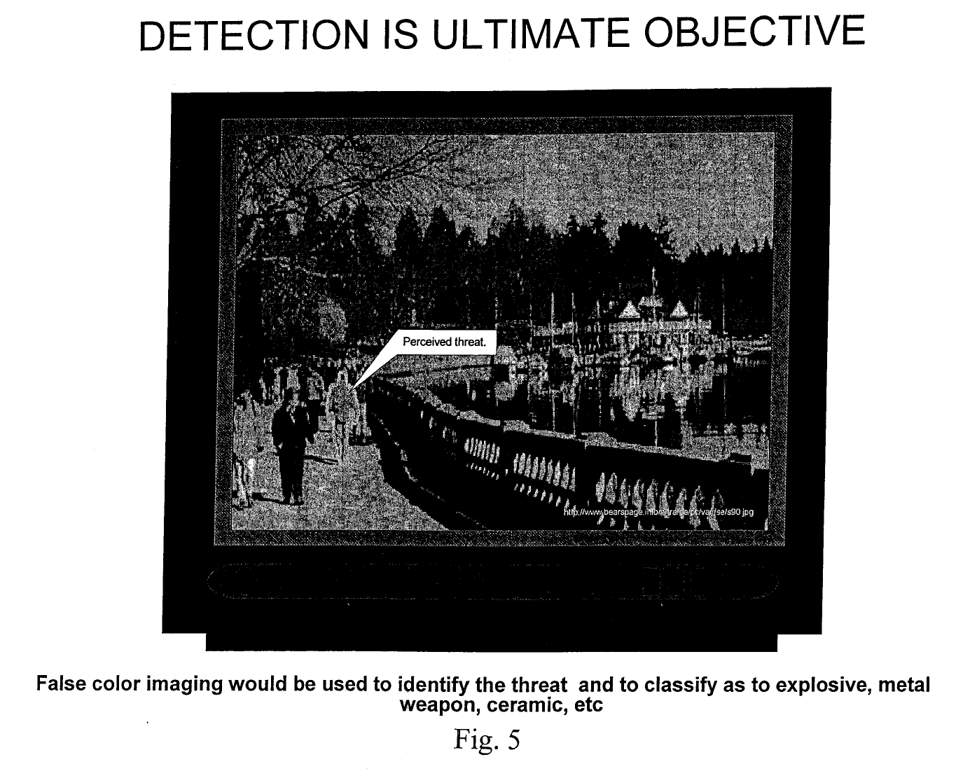

FIG. 5 illustrates an exemplary condition in which the invention could be used in which a perceived threat, the outlined person is presented with a false color image in order to enable easy tracking and interrogation. The superimposed combination of scanned and camera images obtained using the devices in FIG. 4 would appear on a video monitor. Also, points in the scanned image that reflect suspicious radiation can be assigned a vivid false color to stand out in the superimposed scanned and camera images.

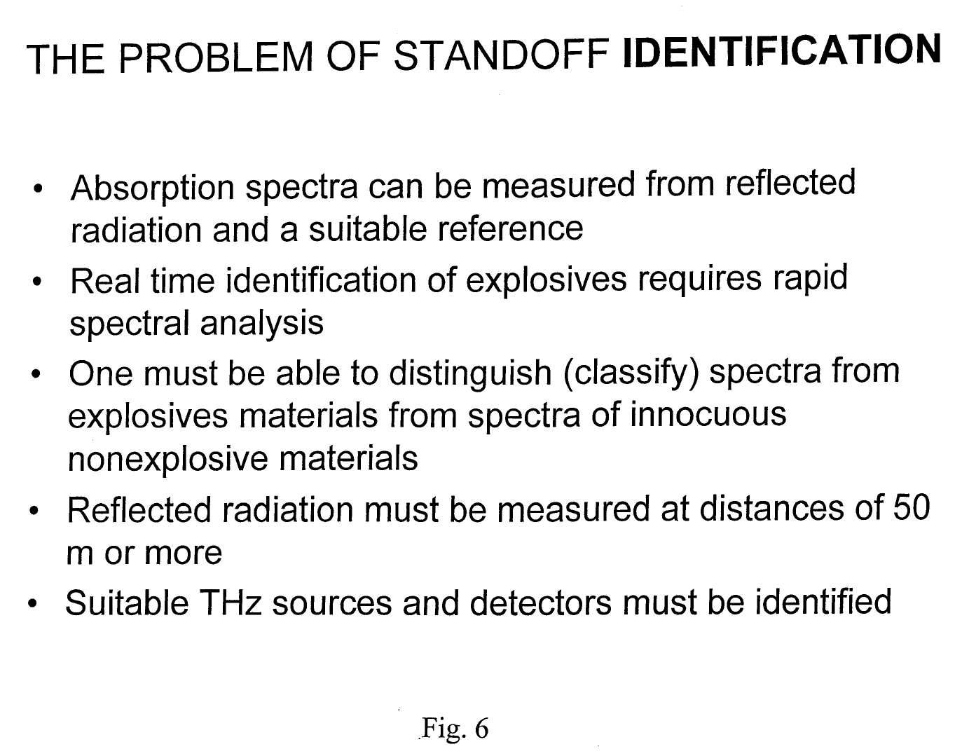

FIG. 6 states the general technical issues that are addressed by the present invention for effective standoff detection and identification of concealed explosives via THz reflection spectroscopy for homeland security applications. In particular, the need for real time operation, and the need to distinguish innocuous materials from explosive materials sets the challenge for the present invention, in addition to the need for sufficient standoff. Also, suitable THz sources and detectors are used to implement the invention.

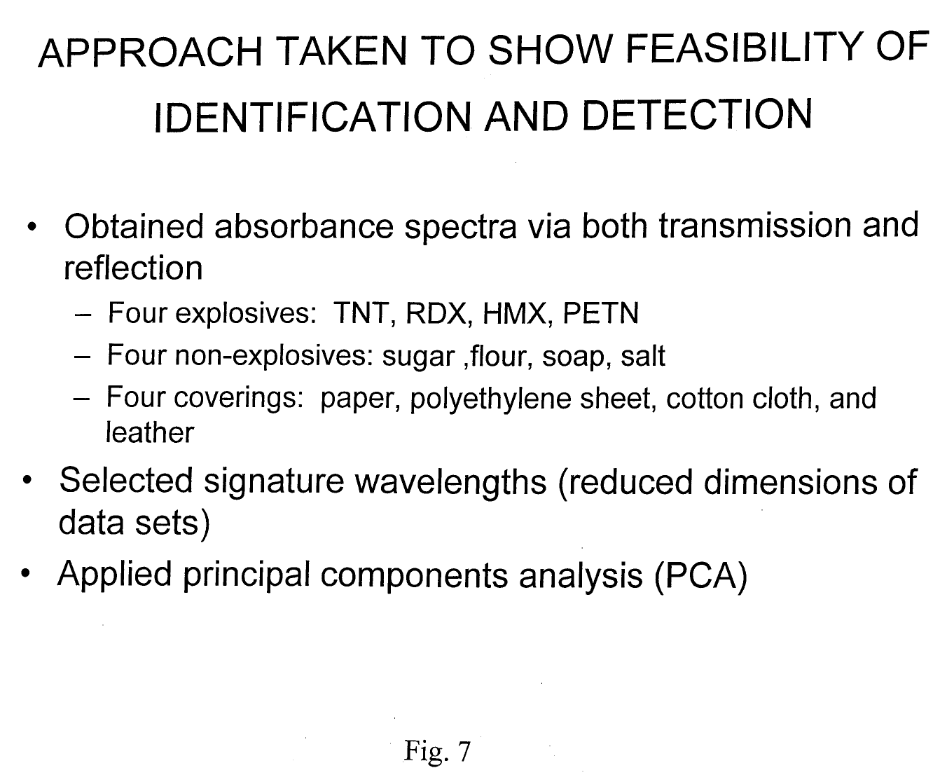

FIG. 7 is a summary of an approach taken to demonstrate the exemplary experimentation for demonstrating identification and detection of concealed explosive materials via THz reflection spectroscopy as set out in further detail below.

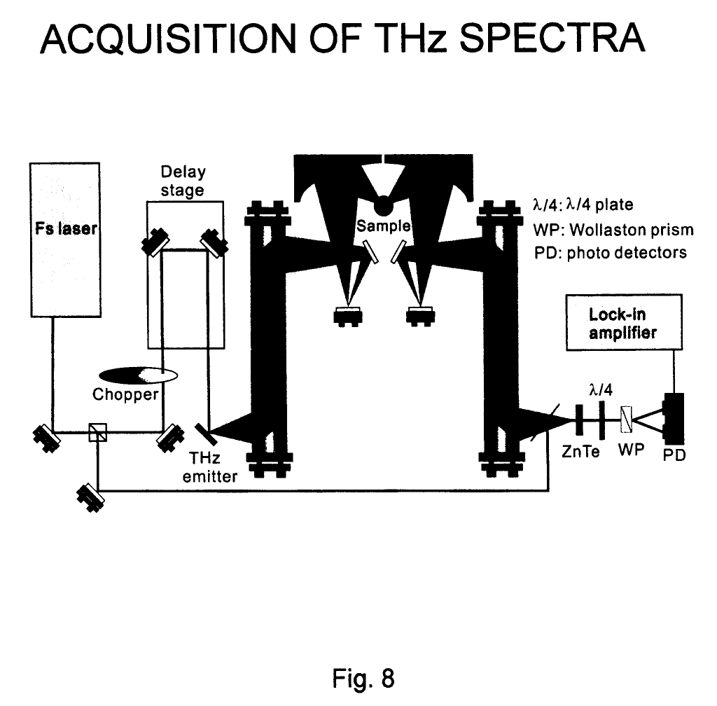

FIG. 8 shows a schematic diagram of typical THz-TDS system used to measure THz reflection spectra of solid materials. The system is based on a coherent pump-probe technique. The femtosecond (Fs) laser beam is split into a pump beam and a probe beam. The pump beam is introduced to a THz emitter for THz generation. The probe beam and the THz pulse are collimated on a ZnTe crystal, inducing the polarization changes between the two components of the probe beam, which is proportional to the THz field. These two polarizations are split by a Wollaston prism (WP) and sent to a pair of balanced photo-detectors.

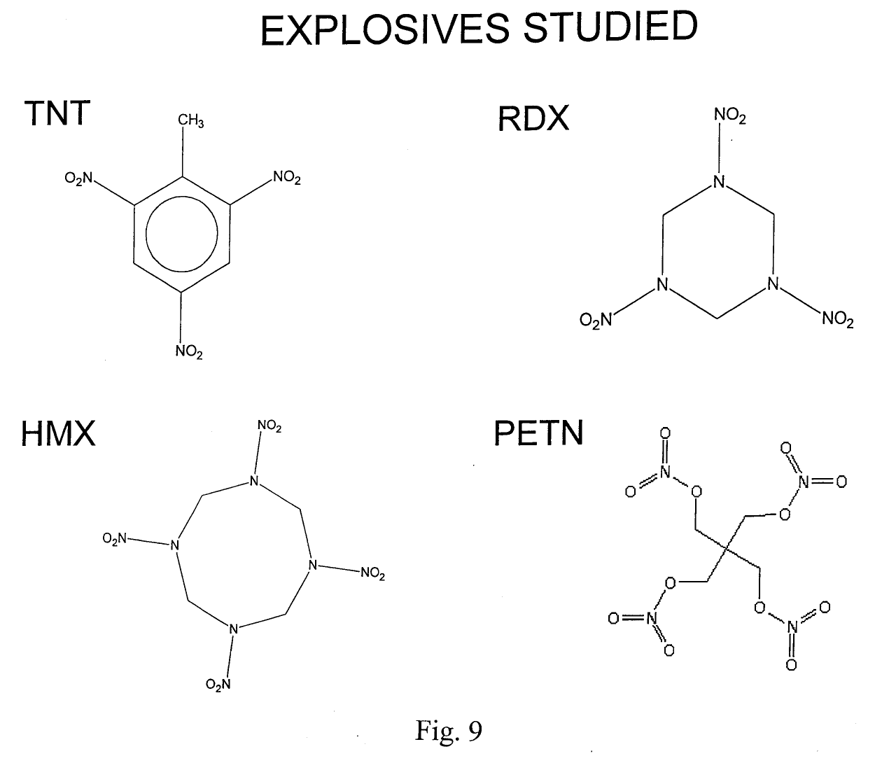

FIG. 9 shows the general molecular structure of the four explosives that were used in the exemplary experimental work that resulted in demonstration of the present invention, TNT, RDX, HMX, and PETN, whose THz absorption spectra were measured and classified to obtain a PCA classification and signature set. The invention can be applied to other explosives and more generally to any material or group of materials under search or which PCA classification data is sufficiently distinct from a material or group of materials that are considered benign.

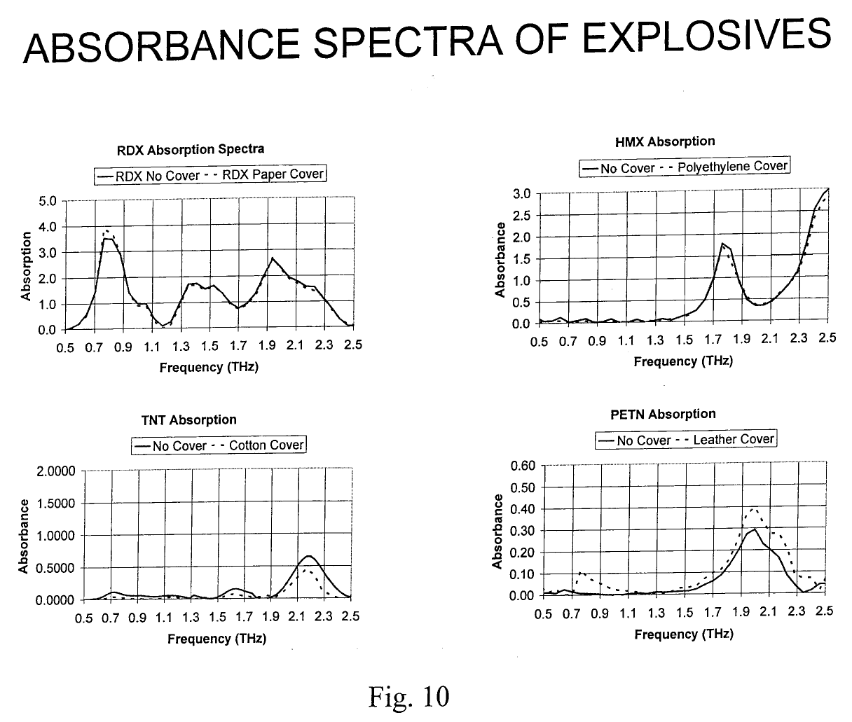

FIG. 10 shows the absorbance spectra of the four explosives examined. These spectra have been baseline corrected, but not normalized. The labeled frequencies indicate the signature frequencies used to classify the spectra. Absorbance data from these spectra were used as the training signature set for classification by PCA.

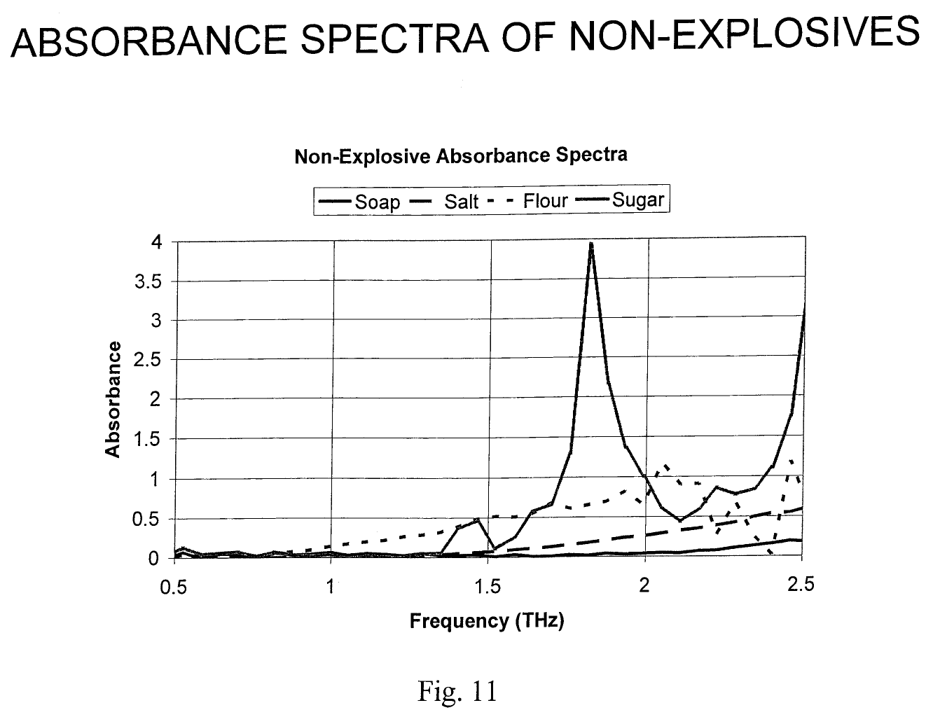

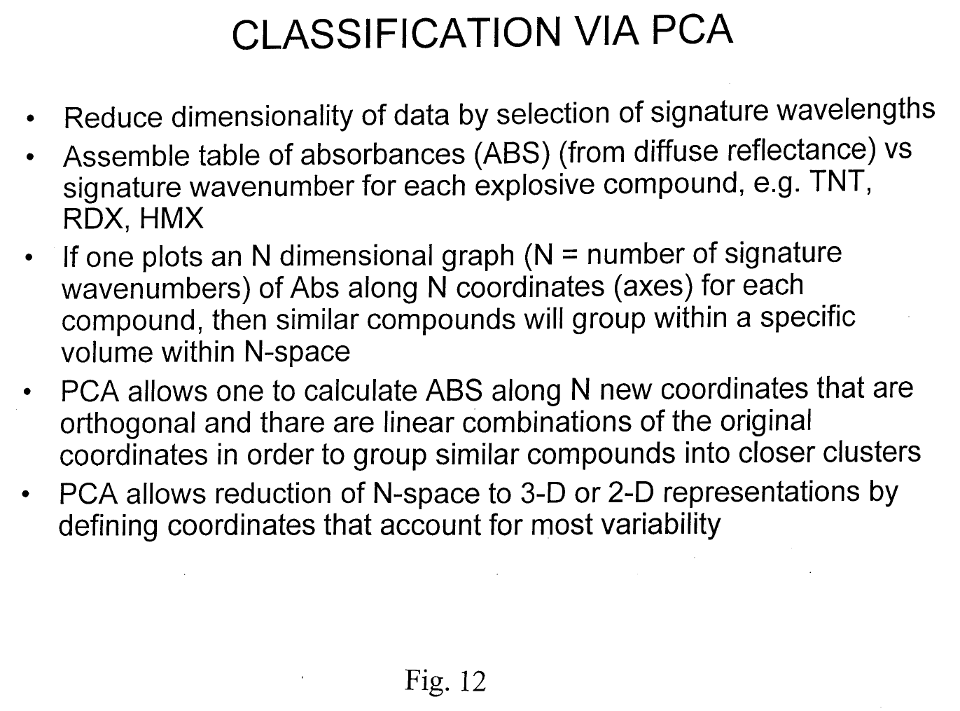

FIG. 11 shows the absorption spectra of non-explosive materials used in the exemplary experiment work. Comparison of the spectra with the spectra of explosive materials used in the experiment was used to test the ability to distinguish the two classes of materials.

Absorption was measured using both transmission and diffuse reflection modes. The set-up for the THz-TDS system schematically shown in FIG. 8 was used for absorption spectra measurements via transmission in the 0.2-2.5 THz range. In the experiment, absorption spectra were taken via both the transmission mode and reflection made for all the explosive and non-explosive compounds under investigation, with and without covering materials. The absorption spectra of explosive and non-explosive samples were obtained by using THZ time domain spectroscopy (TDS). Similar differences were observed between spectra obtained via transmission versus reflectance. Absorption spectra via both transmission and diffuse reflectance were obtained for the same explosive samples covered by either, cloth, paper, plastic, or leather in order to determine if the spectra of the explosives was obscured or distorted. It was found that the distinctive spectra of the explosives could be measured in the presence of the coverings. FIG. 10 shows some of the absorption spectra, via transmission, of the explosives covered and uncovered. These data were used to train and test the classification procedure, to obtain a training signature set for PCA classification. The absorption spectra of the non-explosive materials tested, soap, salt, flour and sugar differ significantly from the spectra obtained for the explosives as is shown below.

Experimentally acquired absorbance spectra, obtained via transmittance without coverings, for the actual explosives TNT, HMX, RDX, and PETN, were analyzed to establish signature frequencies that can be used to identify absorbance spectra that originate from explosives. Frequencies were chosen over the range of 0.5 to 2.5 THz. This range corresponds to the region where common coverings and the atmosphere are most transparent to THz radiation. Table 1 lists the signature frequencies chosen from analysis of the experimentally acquired spectra. None of these frequencies coincide with the narrow water absorption bands observed in the atmosphere.

TABLE 1
Signature Frequencies

| Signature Number | Frequency (THz) | Wave number (cm⁻¹) |
|---|---|---|
| 1 | 0.82 | 27.3 |
| 2 | 1.62 | 54.0 |
| 3 | 1.79 | 59.7 |
| 4 | 2.00 | 66.7 |
| 5 | 2.50 | 83.3 |

Absorbances at these five frequencies observed for the four explosives were used to create a training set for principal component analysis classification of all absorbance spectra. In this approach, the spectra containing many points over the frequency region of 0.5 to 2.5 THz were reduced to spectra containing only 5 points at the selected signature frequencies for classification purposes. Table 2 contains the data of the reduced spectra from the explosives used for training the classification scheme.

TABLE 2
Absorbance Values at Signature Frequencies

| | Frequency (THz) | | | | |
|---|---|---|---|---|---|
| Compound | 0.82000 | 1.620 | 1.790 | 2.00000 | 2.50 |
| RDX | 3.4780 | 0.430 | 0.5400 | 1.8175 | 0.0300 |
| TNT | 0.0623 | 0.145 | 0.0149 | 0.1562 | 0.0094 |
| HMX | 0.0962 | 0.029 | 1.4600 | 0.0220 | 2.3900 |
| PETN | 0.0051 | 0.036 | 0.1170 | 0.2932 | 0.0400 |

The data in Table 2 represent the coordinates of a unique point in 5-dimensional space for each of the listed compounds. In this form, the points representing the four explosive compounds do not fall near each other in the 5-dimensional space. To achieve classification of explosive versus non-explosive spectra, these data must be transformed so that new coordinates of the explosive compounds fall together in a newly defined N-dimensional space, while the coordinates from non-explosive compounds fall away from the cluster of explosive compounds.

Data transformation for classification was achieved by applying principal components analysis (PCA) to the reduced spectra for the four explosive compounds. The PCA classification procedure defines new coordinate axes (principal components) and new coordinates along the axes for each compound (z-scores) by a multivariate regression method that minimizes the variation of the coordinate values along the new coordinate axes. Essentially, a transformation matrix is created that converts the experimental coordinates of absorption versus frequency to the new coordinate system of z score versus principal component.

This procedure causes the new coordinates of the training set (the compounds used in the PCA calculations) to cluster within small volumes in N-space. This effect is most easily visualized when coordinates along three of the new coordinate axes (principal components that represent low variability) are plotted in three dimensions.

Table 3 contains the transformation matrix obtained by performing PCA on the training set data (from the four explosive compounds only).

TABLE 3
Transformation Matrix Obtained from Training Set

| Frequency | PC1 | PC2 | PC3 | PC4 | PC5 |
|---|---|---|---|---|---|
| 0.82 | −0.844672 | −0.302835 | −0.314546 | 0.067734 | 0.302147 |
| 1.62 | −0.092249 | −0.006208 | −0.536212 | 0.063614 | −0.836589 |
| 1.79 | 0.066400 | −0.511607 | 0.330661 | 0.774597 | −0.156563 |
| 2.00 | −0.421017 | −0.062773 | 0.695619 | −0.388935 | −0.428542 |
| 2.50 | 0.310411 | −0.801604 | −0.142528 | −0.489995 | 0.025813 |

The coefficients in the transformation matrix are the weighting factors used at each frequency to convert absorbance to z scores for every principal component.

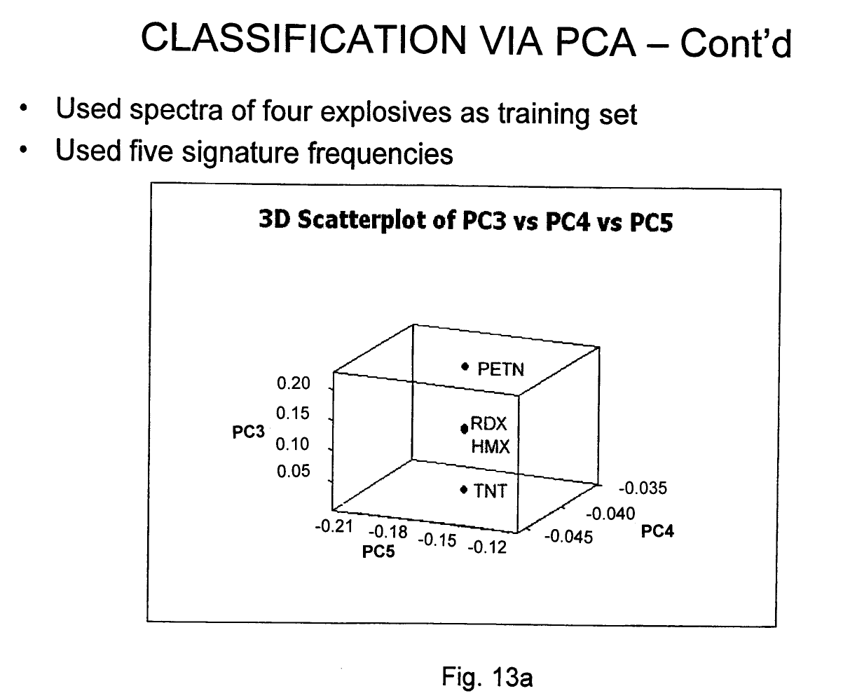

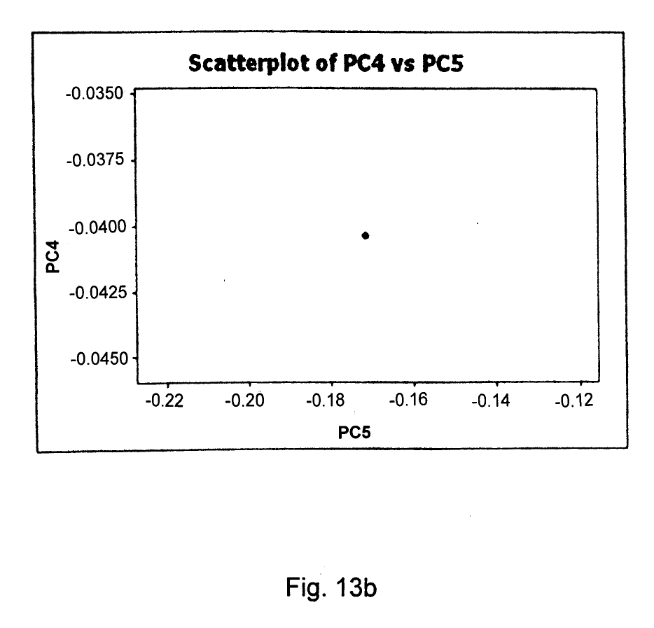

When the training set absorbance data of Table 3 are transformed to principal components, the resulting z score versus principal component data can be visualized by plotting z score versus two or three of the principal components for the four explosive compounds. Such plots are shown in FIGS. 13 and 13a. The 3-D plot shows that all four explosives fall on a line with the only variability shown in the PC3 dimension. When the training set z score data are projected onto the two dimensional PC4-PC5 plane, all four points are superimposed.

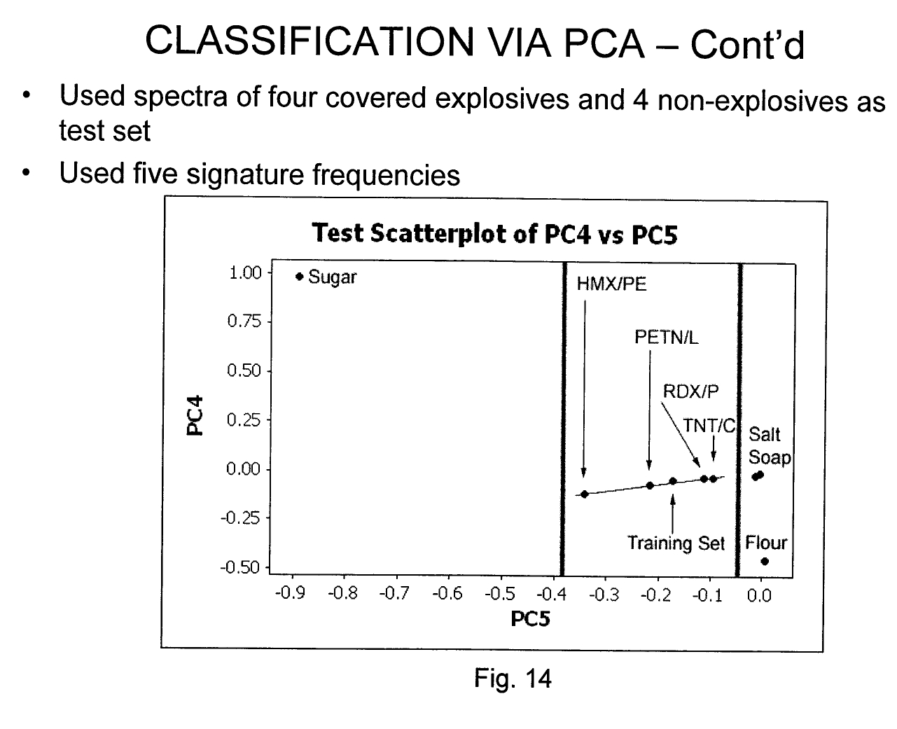

To test to see if classification could be achieved using the principal components analysis performed on the training set, the trained transformation matrix in Table 3 was used to transform absorbance vs frequency data to z score vs principal component data for eight additional spectra, the four spectra of explosives covered with different materials (shown in FIG. 10) and the four non-explosive spectra (shown in FIG. 11). The z scores for all twelve sample spectra (training set included) were plotted along coordinates PC4 and PC5 (as was done in FIG. 13b). This scatter plot is shown in FIG. 14.

As designed, the z score points corresponding to the explosive spectra of the original training set all fall at the same location, as first shown in FIG. 13b. The z score points corresponding to the spectra taken of the four explosives through coverings (shown in FIG. 10) fall on a closely spaced line that includes the training set point. The z score points corresponding to spectra from non-explosive materials fall away from the explosive points. The vertical lines drawn in FIG. 14 define the range of PC5 coordinates over which only explosive spectra fall.

This clustering of the points representing the explosive spectra demonstrates that classification between explosive compounds and non-explosive compounds can be achieved using THz spectroscopy and principal components analysis.

This classification was achieved by first reducing the experimental THz spectra to a plot of absorbance versus only five frequencies, thus preparing for very rapid signal analysis. The five frequencies were chosen from inspection of the spectra and could possibly be further optimized.

To determine if fewer signature frequencies could be used to properly classify explosive and non-explosive compounds, the same PCA classification protocol described above was repeated using only four of the original five signature frequencies listed in Table 1. Three different four-signature frequency classification training sets were generated by eliminating three different signature frequencies (1.62, 1.79 and 2.50 THz) from the data set shown in Table 2. The transformation matrices derived from these three data sets were then used to transform the test data into three different four dimensional principal component spaces. Scatterplots such as the one shown in FIG. 14 were used to display how well the test data could be classified on the basis of four signature frequencies. In all cases, additional scatter of the points representing explosive compounds was observed for the four signature frequency classifications. However, in the case where the 2.50 THz absorptions were not used for training and classification, the classification of explosive compounds vs non-explosive compounds could still be achieved.

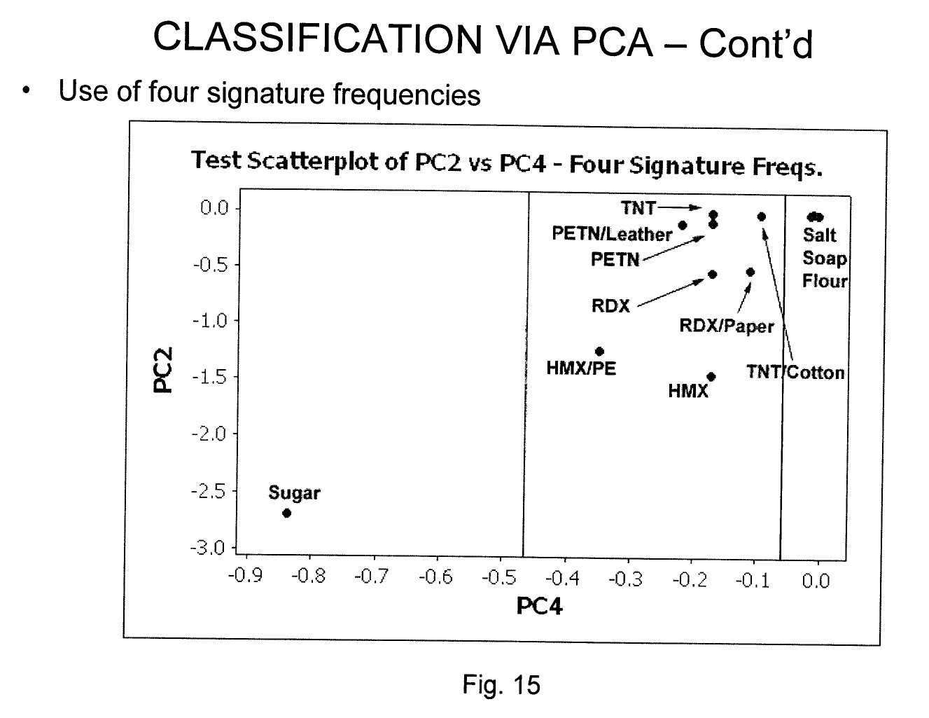

FIG. 15 shows the scatter plot of the z-scores obtained along the PC3 and PC4 axes. In comparison with FIG. 14, it is clear that the explosive data points fall over a larger area of the scatter plot, but that the cluster of explosive compound data points does not overlap the areas occupied by data points from the non-explosive compounds. Thus, classification is still possible using only four signature frequencies, but, from the large scatter of data points it can be inferred that the certainty of classification may be adversely affected. However, improvements in the signal to noise ratio of the experimental measurements and other measures can be used to improve the certainty of classification even if four or fewer signature frequencies are employed.

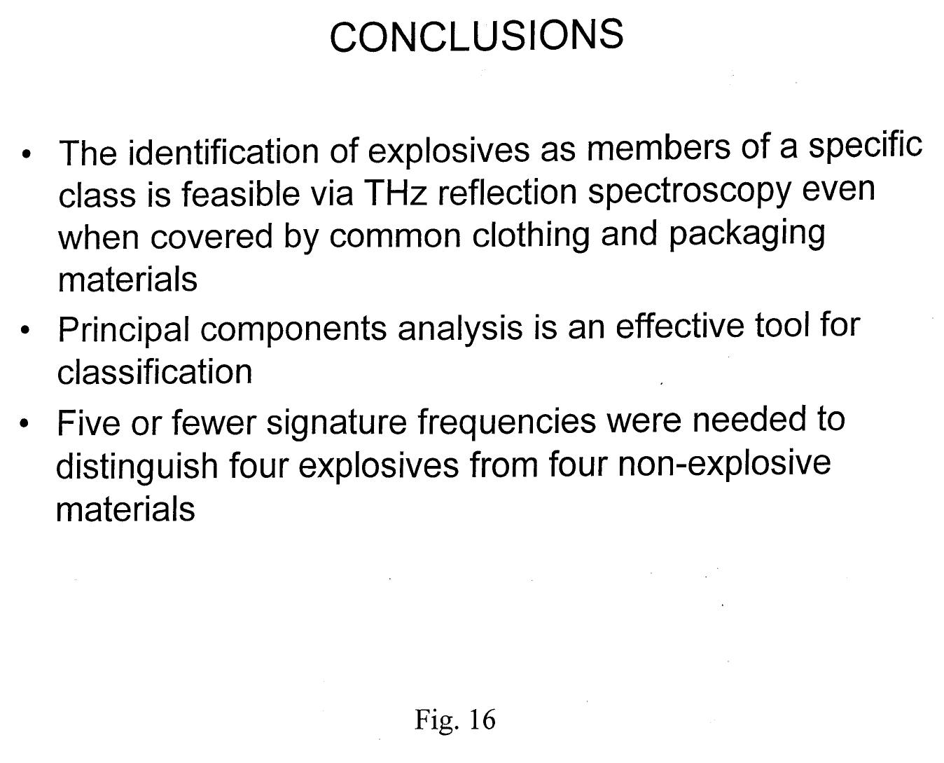

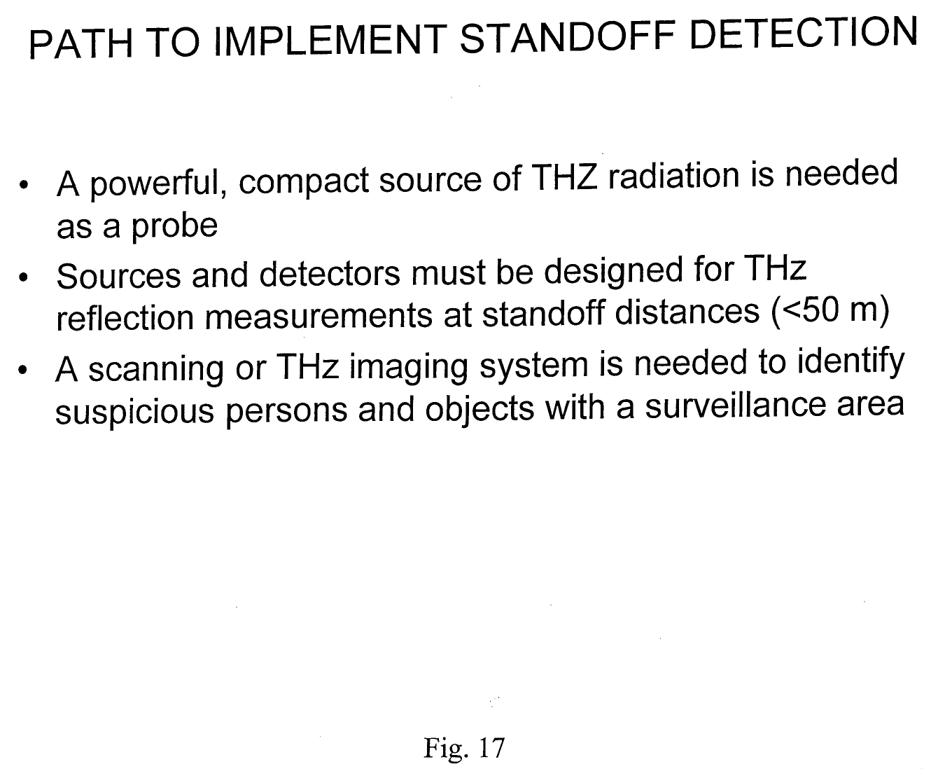

FIGS. 16 and 17 sum up the presentation above. FIG. 16 is a description of conclusions that indicate that detection and identification of explosive materials using THz reflection spectroscopy can be accomplished in combination with classification via principle component analysis. FIG. 17 is a description of steps to be taken to achieve the ability to detect and identify explosive materials at significant distances via THz reflection spectroscopy.

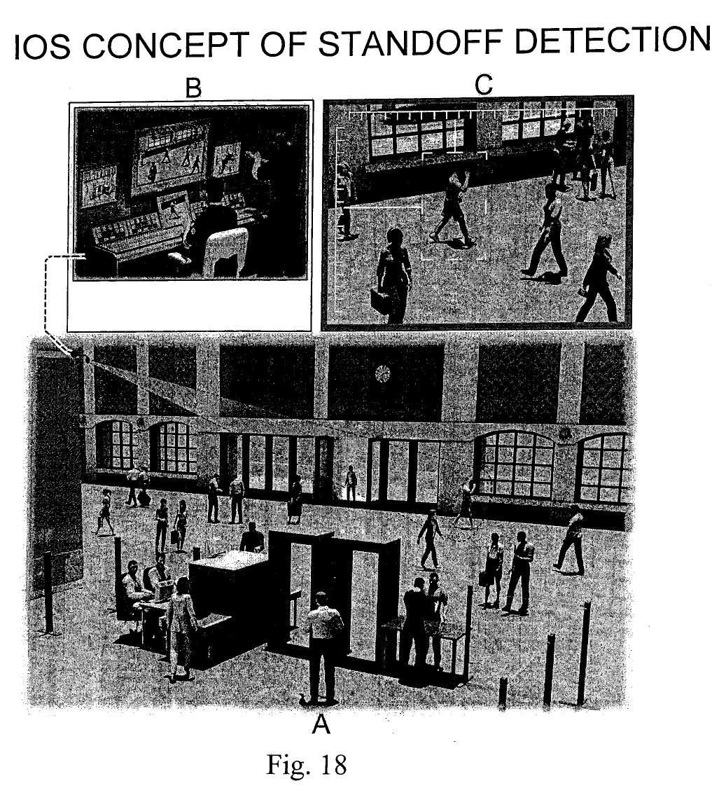

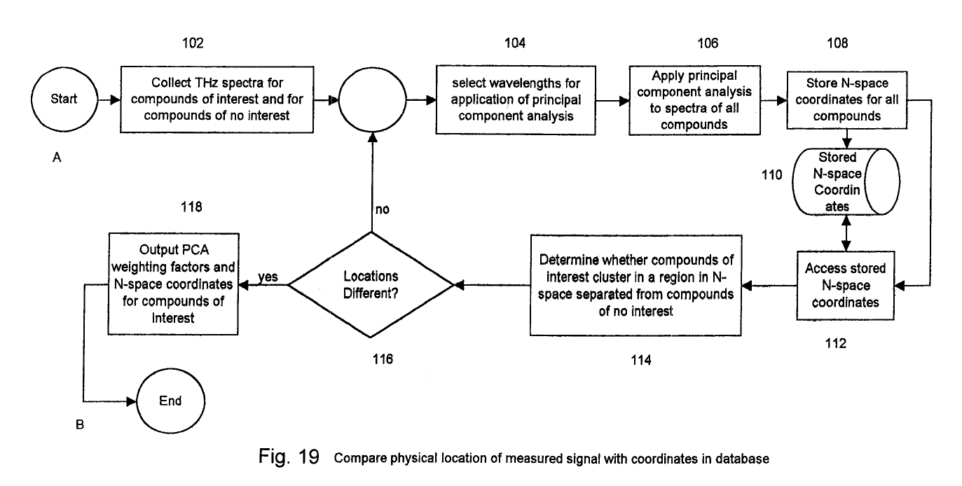

FIG. 18 illustrates an exemplary installation such as in an airport for identifying a subject and operating the standoff explosive detection system as herein described. A is a general view of an area under surveillance with a subject targeted for interrogation. B shows the display for targeting the subject. C shows an exemplary operations center for the system.

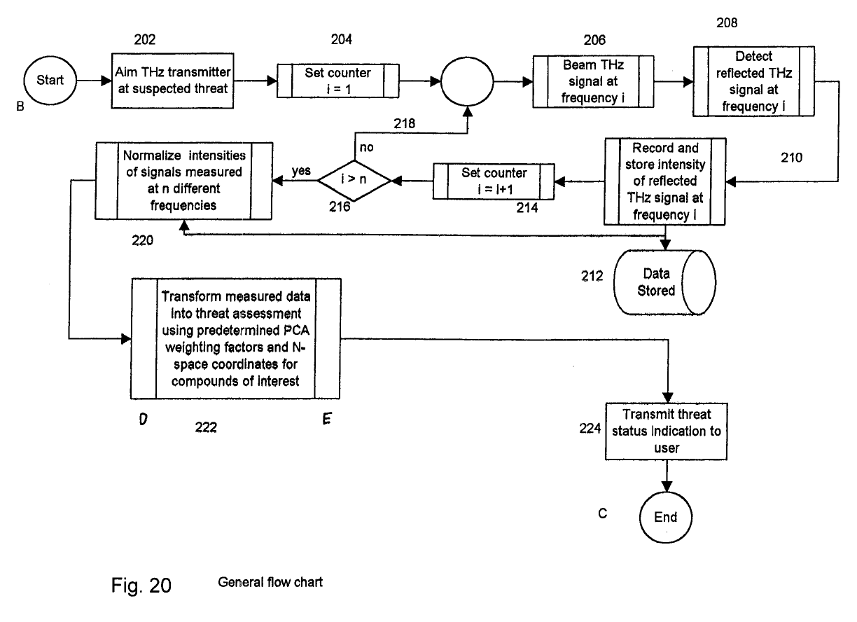

FIG. 20 is a flow diagram indicating logical process to establish criteria for classification and identification of explosive materials vie principle component analysis and THz spectroscopy. It is a chart for the process of obtaining the PCA classification data needed in a system for detecting a set of target materials (also referred to as compounds of interest).

The first step, 102, is to collect terahertz absorption spectra for the compounds of interest (target materials) and for compounds to be excluded (non-target materials). It is understood, in the context of detection of explosives hidden on an individual or in a package, that certain common materials must be excluded from detection, these are the non-target materials (see attachment A). The target materials in this example are the explosives TNT, PETN, RDX, and HMX.

The next step, 104, was to select an initial set of training frequencies. The criteria for the initial set was to select a set that are strong absorption reflections for each of the four explosives, plus a fifth that is additively strong for more than one of them. Also the selected frequencies must exclude absorption spectra for atmospheric effects, namely water. As will be appreciated this step had to be repeated iteratively to obtain good and possibly optimum results.

The next step, 106 is to apply PCA to the selected target frequencies to obtain a set of N-space coordinates, which are stored at 108 in a storage medium 110. An analysis is made to determine if the N-space coordinates for the target set is sufficiently different from that of the excluded or non-target set. The goal is to find a set of frequencies in the absorption spectral range that includes spectra of all of the target materials, that after PCA provides N-space coordinates that are sufficiently different from that of the group of non-target materials, and also excludes reflection from the ambient environment, namely water such that a decision can be made that one of the explosives is or is not present.

Although it is possible that the initial frequency set will provide a useful result, it is expected that the initial frequency selected set will have to be varied in order to obtain a good result. The variation technique begins with varying a single frequency and re-running the PCA. The criteria for iterative selection of training sets is intuitive (from the perspective of a person learned in this technology) and learned based on prior results. In that repetition frequencies should be chosen so that there is significant but not necessarily maximum absorption, and for each selected signature frequency significant absorption should exist for at least two compounds. The frequencies must not correspond to water absorption lines.

The stored N-space coordinates are accessed at 112 and analyzed at 114 to determine whether compounds of interest cluster in a region in N-space separated from compounds of no interest. A decision is made at 116, whether or not the locations are sufficiently different. If not the process is repeated with a new selection of frequency set. If the decision is yes, then at 118 the PCA weighting factors and N-space coordinates for the compounds of interest are outputted to B.

When a set of target frequencies has been identified, the N-space coordinates and weighting factors for that set is stored to be used in field applications of the invention.

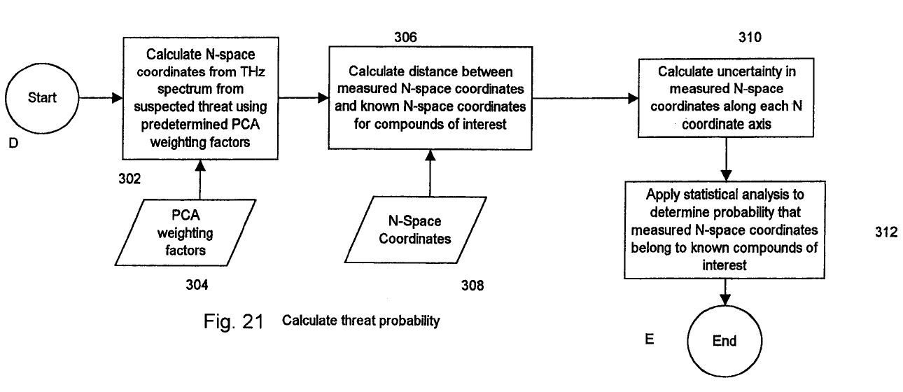

FIG. 21 is a flow diagram indicating logical process to classify unknown materials as either explosive or non-explosive on the basis of their reflection spectra using principle component analysis. Referring to flow chart of FIG. 21 the overall process for interrogating a suspected threat is shown. First at 202 a THz transmitter equipped to transmit THz radiation at the threat is activated. The transmitter can be discreetly cycled to each of the final selected frequencies or scanned through them. As shown at 204 a counter is set for the first frequency, which as at 206, is beamed at the threat. At 208 the reflected THz signal is detected. At 210 the reflected THz signal is recorded and it is stored at 212. Then at 214 the control counter cycles to the next frequency. The control counter will continue to cycle through each of the n preset frequencies until reflection at each of them has been obtained and stored at which point the decision process 216 will implement the next step which is either to recycle for the next frequency at 218 or if the process is finished to proceed with the next step at 220. This procedure could be repeated a number of times and the results summed or averaged to obtain more meaningful data if for example there is interference present or if the signal is weak. Next at 220 the intensities of the signals at the n different frequencies is normalized. Then at 222 the measured data is transformed into a threat assessment using the predetermined PCA weighting factors and N-space coordinates for the compounds of interest from B of FIG. 20. Finally at 224, the threat status is transmitted to a user.

There are a number of alternative embodiments for transmitting the interrogating THz radiation and for processing the reflected signal. The interrogating THz beam may be continuous wave (cw), pulsed or modulated. All three types of THz beams made be stepped or scanned through specific signature frequencies. Both pulsed and modulated beams may be used to isolate the signal of interest from unwanted background signals.

In an alternate embodiment, the interrogating beam may also be broadband, i.e. contain a broad range of THz frequencies simultaneously. Broadband beams may be cw, pulsed, or modulated. In this embodiment, if a broadband interrogating beam is used, the reflected THz radiation must be detected at individual specific signature frequencies. Detection at specific frequencies may be achieved by placing narrow band filters in front of multiple detectors.

Passive detection of reflected THz radiation is also possible. In this case, reflections of ambient broadband THz radiation (from the sun or other sources) can be detected at multiple specific signature frequencies using filters and multiple detectors.

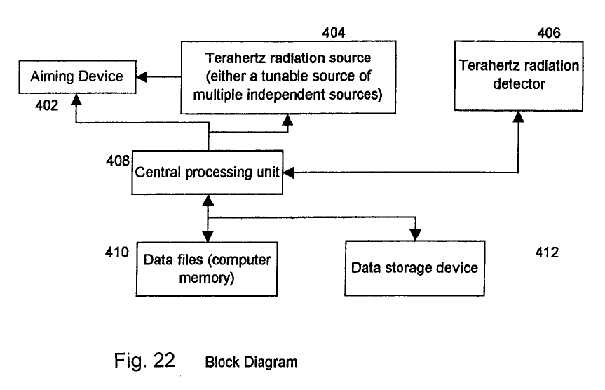

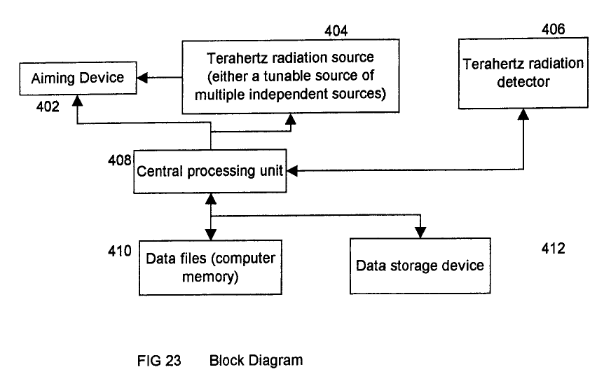

FIG. 22 is a flow diagram indicating logical process to estimate the probability that an unknown material has been properly classified as explosive or non-explosive using principle component analysis and THz reflection spectroscopy. FIG. 22 shows the steps for transforming the measured data into a threat assessment (step 222 of FIG. 21). This starts at 302 by calculating N-space coordinates from the THz spectrum from the possible threat using the predetermined PCA weighting factors that are available from storage 304. This results in the measured N-space coordinates. Next the distance between the measured N-space coordinates and the predetermined N-space coordinates for the target material is calculated at 306, the predetermined N-space coordinates for the target materials being available from storage 308. Then, at 310 the uncertainty is calculated in the measured N-space coordinates along each coordinate axis. Next at 312 statistical analysis is applied to determine the probability that the measured N-space coordinates belong to the compounds of interest. This is the threat assessment of step 222 above. The result is output at E which ends step 222 of FIG. 21.

FIG. 23 is a block diagram of a system for performing the method described above. The system comprises an aiming device 402 for directing radiation at a target. A radiation source 404 provides the THz radiation to the device 402. A radiation detector 406 will receive the reflected THz radiation. The process is controlled by a central processing unit 408. The stored information, weighting factors, n-space coordinates and the immediate data obtained are all stored in data files in a computer memory 410, and retained on a data storage device 412.

In a further implementation of the invention, it is considered that target (designated) materials may not be clustered in a single cluster of n-space coordinates, but might be clustered in a plurality of such clusters such as if the target materials are a large family of materials such as explosives or drugs. Therefore a more statistically significant distinction may be available between materials of interest and those of no interest if multiple clusters are available for materials of interest.

While the invention is described in terms of a specific embodiment, other embodiments could readily be adapted by one skilled in the art. Accordingly, the scope of the invention is limited only by the following claims.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

What we claim is:

1. Apparatus for detecting a material of a designated group of materials comprising;
a source of a beam of terahertz radiation containing a set of frequencies to construct a frequency signature set, which is characteristic of each member of the group;
at least one device for storing said construct;
at least one device for reflecting said terahertz radiation including said signature set characteristic for a suspect material;
wherein said beam including said signature set of said suspect material is directed for comparison with said stored construct for determining if said suspect material is a member of said class.

2. Apparatus of claim 1, wherein the beam of terahertz radiation is pulsed.

3. Apparatus of claim 1, wherein the pre-established class of materials comprises one or more of the explosives RDX, TNT, PETN or HMX.

4. A method of interrogating a subject for presence of any material that is a member of a designated group of materials and for distinguishing comprising;
exposing each material selected to belong to said class to terahertz radiation;
detecting the reflected radiation from each of said materials;
determining a frequency signature set for which PCA classification has been determined that is sufficiently clustered;
carrying out a principle component analysis of the reflected radiation in each instance;
determining a signature frequency set in the reflected radiation which permits the analysis to construct a PCA classification for the materials belonging to the class;
storing data defining said classification;
detecting reflected terahertz radiation from a subject;
carrying out a principle component analysis on said reflected terahertz radiation to obtain PCA classification data characterizing the subject; and
comparing that classification data with the previously stored classification data for determining whether or not the material that reflected the THz radiation is in the designated group of materials.

5. Apparatus of claim 4, wherein the beam of terahertz radiation is pulsed.

6. Apparatus of claim 4, wherein the designated group of materials comprises one or more of the explosives RDX, TNT, PETN or HMX.

7. A method of determining whether or not a suspect material is a member of a designated group of materials which has been characterized by a signature frequency set of absorption spectra for which a PCA classification has been determined;
exposing the suspect material to terahertz radiation beam comprising said signature set of frequencies;
detecting reflected terahertz absorption spectra at the signature set of absorption spectral frequencies from the suspect material;
carrying out a principle component analysis on said reflected absorption spectra for constructing a PCA classification characterizing the suspect material; and
comparing the PCA classification characterizing the suspect material with the PCA classification characterizing the members of the designated group in a manner to determine whether or not there is a match therebetween.

8. The method of claim 7, further comprising:
scanning said beam over scan points of said suspect material;
detecting the reflected radiation at each scan point;
carrying out said principle component analysis on the reflected radiation at each scan point for constructing a PCA classification of the reflected radiation at each scan point; and
comparing the PCA classification of the suspect material at each scan point with the PCA classification for the designated group of materials.

9. The method of claim 7 including the step of exposing a suspect material to pulsed terahertz radiation.

10. Apparatus of claim 7, wherein the pre-established class of materials comprises one or more of the explosives RDX, TNT, PETN or HMX.

11. The method of claim 8 comprising the steps of exposing a suspect material to terahertz radiation comprising said selected frequencies;
detecting reflected radiation from said suspect material;
carrying out a principle component analysis on said radiation at said selected frequencies for constructing a PCA classification of the suspect material; and
comparing the PCA classification of the suspect material to said stored PCA classification.

12. Apparatus of claim 11, wherein the beam of terahertz radiation is pulsed.

13. Apparatus of claim 11, wherein the pre-established class of materials comprises one or more of the explosives RDX, TNT, PETN or HMX.

14. Apparatus for detecting the presence of a material as belonging to a designated group of materials, said apparatus comprising;
a source of a beam of terahertz radiation comprising a set of frequencies having been previously determined to permit PCA classification data that is distinguishable from that of non-target material;
said apparatus including means for storing said PCA classification data and means responsive to reflected terahertz radiation to determine PCA classification data for the suspect material;
means for comparison of the PCA classification data of the suspect material with the previously stored PCA classification data of target and
means for determining a threat level based on analysis of the closeness of match of the PCA classification data of the suspect material to that of the target material.

15. The method of determining whether or not a suspect material is a member of a predefined class of members each characterized by a frequency signature set constructed by principle component analysis (PCA) at each of a plurality of frequencies at which the members share an identifiable absorbance feature, said method comprising;
exposing the suspect material to terahertz radiation beam comprising said plurality of frequencies;
detecting reflected terahertz radiation from the suspect material;
carrying out a principle component analysis on said reflected radiation for determining PCA classification data for the suspect material and
comparing the PCA classification data of the suspect material with the PCA classification data of the members of the predefined class in a manner to determine a threat level from the suspect material.

16. A method as in claim 15 including the steps of scanning said beam over said suspect material, detecting the reflected radiation at each scan point, carrying out said principle component analysis on the reflected radiation at each scan point for constructing a signature set on the reflected radiation at each scan point, and comparing the signature set characterizing the suspect material at each scan point with the signature set characterizing the members of the predefined class.

17. A method as in claim 15 including the step of exposing a suspect material to pulsed terahertz radiation.

18. A method for determining the likely presence of a material that is a member of a class of materials comprising;
a) determining classification data for distinguishing the material as a member of a designated group comprising;
i) exposing each material of the designated group to terahertz radiation;
ii) detecting in a detector reflected radiation from each prospective member;
iii) selecting frequencies in the reflected radiation at which a plurality of members of the group share an identifiable absorbance characteristic and storing the frequency data in a specially programmed computer;
iv) in a specially programmed computer, carrying out a principle component analysis on said selected frequencies for obtaining PCA classification data for the class and storing said PCA classification data in a specially programmed computer.
b) determining the presence or absence of a suspected material comprising;
i) exposing a suspect material to terahertz radiation comprising said selected frequencies;
ii) using a detector detecting reflected radiation from said suspect material;
iii) in a specially programmed computer carrying out a principle component analysis on said radiation at said selected frequencies for constructing a signature set characteristic of the suspect material;
iv) in a specially programmed computer comparing the signature set characteristic of the suspect material to said stored signature set;
v) and providing in a display or output device a determination of the likelihood of presence of a suspect material.

19. A method for standoff interrogation of subjects for the detection of explosives comprising;
directing THz radiation at the subject in a range that will provide absorbance reflection frequencies of a predetermined frequency signature set for the designated materials for which PCA classification data has been obtained and which has been stored;
comparing PCA classification data of absorbance reflection frequencies from the subject with the stored PCA classification data for the designated materials;
determining a probability level of likelihood that one of the designated materials is present.

20. The method of claim 19 wherein the designated materials comprise explosives.

21. The method of claim 20 wherein the designated materials are TNT, PETN, HTM and RDX

22. A method of determining whether or not a suspect material is a member of a designated group of materials which has been characterized by a signature frequency set of absorption spectra for which a PCA classification has been determined;
detecting reflected terahertz absorption spectra at the signature set of absorption spectral frequencies from the suspect material;
carrying out a principle component analysis on said reflected absorption spectra for constructing a PCA classification characterizing the suspect material; and
comparing the PCA classification characterizing the suspect material with the PCA classification characterizing the members of the designated group in a manner to determine whether or not there is a match therebetween.
